(19) United States
(12) Patent Application Publication
(10) Pub. No.: US 2025/0370125 A1
(43) Pub. Date: Dec. 4, 2025

(54) ACTIVITY DETECTION USING WI-FI SIGNALS

(71) Applicant: DISH Network Technologies India Private Limited, Bengaluru (IN)

(72) Inventor: Arun Pulasseri Kalam, Bangalore (IN)

(21) Appl. No.: 18/788,858

(22) Filed: Jul. 30, 2024

(30) Foreign Application Priority Data
May 29, 2024 (IN) 202441041830

(51) Int. Cl. G01S 13/89; G01S 13/32

(52) U.S. Cl. CPC G01S 13/89; G01S 13/32

(57) ABSTRACT

A method may include receiving a wireless signal from the environment by a receiver. The method may include determining, at least one of phase information or amplitude information associated with the wireless signal. The method may include generating, using a continuous wavelet transformation, at least one of phase data or amplitude data based on the phase information or the amplitude information, respectively. The method may include providing at least one of the phase data or the amplitude data to an image generation module executed by the receiver. The method may include processing, by the image generation module executed by the receiver, at least one of the phase data or the amplitude data to generate an image of the environment. The method may include detecting, by the receiver and based on the image, the object within the environment.

### CROSS REFERENCE TO RELATED APPLICATIONS

This application claims priority to Indian Provisional Patent Application No. 202441041830, filed on May 29, 2024, in the Indian Intellectual Property Office, the disclosure of which is incorporated by reference in its entirety for all purposes.

### BACKGROUND

The proliferation of wireless technologies has significantly transformed the landscape of connectivity, particularly through the widespread deployment of Wi-Fi technology. This transformation has facilitated the emergence and integration of various Wi-Fi devices and smart technologies into our daily lives, enabling unprecedented levels of automation and convenience. Further, traditional activity monitoring methods, such as video surveillance, often face pushback due to privacy concerns, underscoring the need for non-intrusive alternatives. Thus, improved methods and techniques are required which can increase accuracy of Wi-Fi based detection in existing and upcoming Wi-Fi systems.

### BRIEF SUMMARY

A method may include receiving, by a wireless circuitry of a receiver, a wireless signal from the environment. The method may include determining, by the wireless circuitry of the receiver, at least one of phase information or amplitude information associated with the wireless signal. The method may include generating, by the receiver and using a continuous wavelet transformation, at least one of phase data or amplitude data based on the phase information or the amplitude information, respectively. The method may include providing, by the wireless circuitry of the receiver, at least one of the phase data or the amplitude data to an image generation module executed by the receiver. The method may include processing, by the image generation module executed by the receiver, at least one of the phase data or the amplitude data to generate an image of the environment. The method may include detecting, by the receiver and based on the image, the object within the environment. Other embodiments of this aspect include corresponding computer systems, apparatus, and computer programs recorded on one or more computer storage devices, each configured to perform the actions of the methods.

In some embodiments, the method may include any of the following features. The method may include detecting the object, including classifying, using a machine learning model, the object based into one of a plurality of classifications. The method may include receiving, by the machine learning model, an input may include the image of the environment. The classifying is performed as an output of the machine learning model. The method may include providing a data set may include phase information and amplitude information to the machine learning model; retraining the machine learning model using the data set; and providing, feedback to the machine learning model based on the image generated in the environment. The amplitude information may include CSI amplitude information. The phase information may include CSI phase information. The method may include, performing, by the receiver, principal component analysis on at least one of the phase information and the amplitude information. The method may include determining, by the receiving unit, channel state information associated with the wireless signal. The convolution neural network may be a LeNet-5 model. Implementations of the described techniques may include hardware, a method or process, or computer software on a computer-accessible medium.

A system may include a transmitter configured to transmit an emitted wireless signal. The system may include a receiver, may include a wireless circuitry; an image generation module; one or more processors; and a computer memory may include instructions that, when executed by the one or more processors, cause the system to perform operations to: receive, by the wireless circuitry of a receiver, the modified wireless signal from the environment, the modified wireless signal based on the emitted wireless signal modified by the object in the environment; determine, by the wireless circuitry of the receiver, at least one of phase information or amplitude information associated with the modified wireless signal; generate, by the receiver using continuous wavelet transformation, at least one of phase data or amplitude data based on the phase information or the amplitude information, respectively; provide, by the receiver, at least one of the phase data or the amplitude data to the image generation module executed by the receiver; process, by the image generation module executed by the receiver, at least one of the phase data or the amplitude data to generate an image of the environment; and detect, by the receiver and based on the image, the object within the environment based on the modified wireless signal. Other embodiments of this aspect include corresponding computer systems, apparatus, and computer programs recorded on one or more computer storage devices, each configured to perform the actions described with respect to the system.

In some embodiments, any combination of the following features may be included. The system may be configured such that the transmitter and the receiver provide a wireless network. Detection of the object within the environment may further include detecting motion of the object. The system may include utilizing, by the system, a classification model to classify the motion of the object into one or more classifications. The transmitter or the receiver may be a set top box. The transmitter or the receiver may be a set top box. The machine learning model may be a lightweight model or an edge ai model. The system may be implemented in an edge device. Implementations of the described techniques may include hardware, a method or process, or computer software on a computer-accessible medium.

Aspects of the disclosed technology may include a system comprising a transmitter configured to transmit an emitted wireless signal; a receiver, comprising a wireless circuitry; an image generation module; one or more processors; and computer memory comprising instructions that, when executed by the one or more processors, cause the system to perform operations. The instructions may cause the system to receive, by the wireless circuitry of a receiver, the modified wireless signal from the environment, the modified wireless signal based on the emitted wireless signal modified by the object in the environment; determine, by the wireless circuitry of the receiver, at least one of phase information or amplitude information associated with the modified wireless signal; generate, by the receiver using continuous wavelet transformation, at least one of phase data or amplitude data based on the phase information or the amplitude information, respectively; provide, by the receiver, at least one of the phase data or the amplitude data to the image generation module executed by the receiver; process, by the image generation module executed by the receiver, at least one of the phase data or the amplitude data to generate an image of the environment; and detect, by the receiver and based on the image, the object within the environment based on the modified wireless signal. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings illustrate embodiments of the disclosed technology and, together with the description, serve to explain the principles of the invention. The drawings are intended to provide a clear understanding of the invention's design, function, and operational advantages, without limiting the invention to the specific embodiments shown.

FIG. 1 is an example system and process which may be used for detecting activities using wireless signals according to aspects of the disclosed technology.

FIGS. 2A-2C various aspects related to detection through wireless signals according to aspects of the disclosed technology.

FIG. 3 relates to a training process of a machine learning algorithm according to aspects of the disclosed technology.

FIG. 4 depicts an example method according to aspects of the disclosed technology.

FIG. 5 depicts example experimental results according to aspects of the disclosed technology.

FIG. 6 depicts an example computer system according to aspects of the disclosed technology.

### DETAILED DESCRIPTION

Existing techniques for detecting or classifying motion using wireless signals (e.g., Wi-Fi signals or Wi-Fi networks) are limited in several regards. Such techniques rely on specialized hardware setups or configurations. Further, these techniques are based on the use of specific channels of a transmitter or a receiver. Thus, they may not be generalized to be used on any hardware which may have a transmitter and a receiver. Additionally, the specialized hardware and/or setup requires specialized machine learning models which are only applicable or configured for that hardware. Thus, for example, these existing techniques cannot leverage mesh networks which have multiple nodes to transmit and/or receive wireless signals.

Additionally, existing techniques may combine multiple parts of a received wireless signal, such as phase information and amplitude information, in specific ways (e.g, specific weights) to generate a combined signal. The combined signal may be analyzed for detecting motion. Existing techniques also use specific preprocessing or filtering of signals prior to analysis. For example, the existing techniques may also utilize on principal component analysis (PCA) for evaluating the components of the combined signal. Similarly, existing techniques may rely on a phase shift or an amplitude difference between a transmitted signal and a received signal rather than only the phase or amplitude of the received signal. The existing techniques may utilize the phase shift or the amplitude difference in situations where there is high interference or low signal strength. The specificity required by these techniques limit the generalized use of wireless transmitters and receivers for Wi-Fi sensing.

Additionally, after receipt of the signal, the accuracy of the detection and/or classification is limited. For example, and as further explained herein, the use of Digital Wavelet Transformation (DWT) techniques in existing methods limits the accuracy which may be obtained.

The disclosed technology solves the above problems. The disclosed technology may include a system for detecting motion and/or activities within an environment through the utilization of wireless signals, including Wi-Fi signals. Aspects of this technology include capturing Wi-Fi signal reflections, altered by motion within a specified area. The disclosed technology may processes wireless signals using Continuous Wavelet Transformation (CWT) to isolate signal characteristics indicative of various activities. A subsequent step may involve the classification of these activities via a machine learning algorithm, tailored to identify specific movements or presence within the environment. This technology may be integrated with existing Wi-Fi infrastructure, offering a solution that is both non-invasive and respectful of privacy concerns. The technology may span multiple settings, from residential to healthcare.

In at least some embodiments, a Wi-Fi sensing system may employ Continuous Wavelet Transformation (CWT). CWT is a method or technique that represents a departure from Digital Wavelet Transformation (DWT) based methods. Compared to existing techniques, relying on DWT, CWT provides higher accuracy, reliability, and potential to integrate wireless signal (e.g., Wi-Fi based) detection techniques with other techniques. Simultaneously, CWT techniques are useful and quick enough to allow for a high frequency wireless signal (e.g., a Wi-Fi signal) to be processed and for classification to occur in real-time.

CWT may offer a refined analysis of Wi-Fi signal reflections, enabling the detection of human activities with an accuracy within a range of about 98% to about 99%, depending on the activity being detected. Using CWT, the Wi-Fi sensing system may address privacy concerns associated with conventional monitoring techniques and provide greater accuracy and reliability of activity detection over conventional approaches.

Aspects of the disclosed technology include the use of CWT to analyze the envelope of Wi-Fi signal reflections caused by human movement within a space. This method not only surpasses the limitations of previous techniques in terms of accuracy but also addresses privacy concerns associated with traditional surveillance methods, such as video cameras. By utilizing existing Wi-Fi infrastructure, the invention offers a non-intrusive, cost-effective solution for a wide range of applications, from smart home automation to security and elderly care monitoring.

Further features of the disclosed technology include its ability to operate in real-time, providing feedback and alerts based on detected activities. This capability is important for applications requiring timely responses, such as security systems in smart homes or patient monitoring in healthcare settings. Additionally, the system's design allows for dynamic adaptation to the specific characteristics of the environment, enhancing detection accuracy and minimizing false positives.

The incorporation of a user interface may enable customization of detection parameters and review of activity logs, offering users control and insight into the system's operation. Through the integration of advanced signal processing and machine learning, the technology may detect and learns from the environment, improving its functionality over time.

The technology also includes a feedback mechanism to enhance user engagement and system accuracy. By allowing users to provide input on activity detection accuracy, the system can fine-tune its algorithms, ensuring continuous improvement over time.

The system's capability to encrypt data addresses privacy and security concerns, safeguarding sensitive information. The flexibility of the technology extends to its deployment, as it can be integrated into various Wi-Fi-enabled devices, offering scalability and ease of installation across different environments.

Additionally, the technology may utilize Channel State Information (CSI) and Received Signal Strength Indication (RSSI) for wireless signal (e.g., Wi-Fi) based activity recognition. Channel State Information (CSI) contains characteristics of a communication channel, and may detail a signal's path from sender to recipient. This may encompass the signal's reaction to various influences like scattering, fading, and attenuation due to distance, collectively analyzed through a process known as channel estimation.

In overview, the disclosed technology allows for detection of a transmitted signal which has been modified or altered by the presence of a subject. This altered signal is referred to as the modified wireless signal or the altered wireless signal. The altered wireless signal can be received at a receiver. The modified wireless signal can be analyzed using CWT techniques to generate data. The generated data may be amplitude data and/or phase data. A scalogram can be generated from the generated data from amplitude data alone or from phase data alone. The scalogram can be analyzed using a machine learning model to determine the subject, the action taken by the subject, and/or an object which may be modifying the altered signal. Amplitude data and phase data may be CSI based amplitude data and CSI based phase data, respectively.

### Example Systems and Methods

The following examples illustrate various embodiments of the disclosed technology, aligned with the figures previously described, offering a detailed view of how the system operates within various settings.

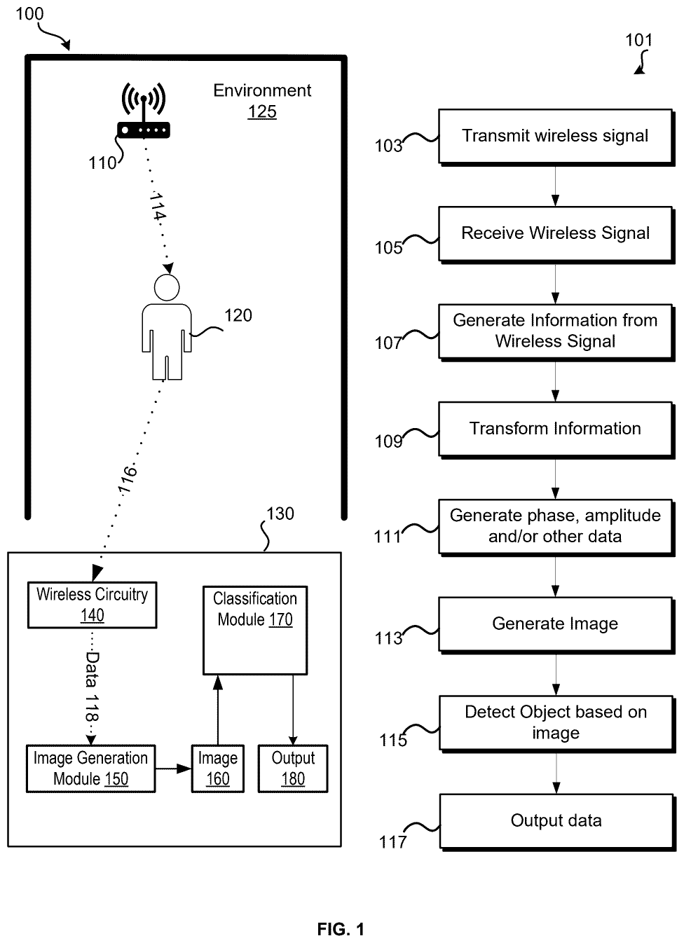

FIG. 1 illustrates a system 100 and a process 101 related to detecting objects or activity detection within an environment 125, according to certain embodiments. The system 100 may include a transmitter 110, a subject 120 within an environment 125, and a receiver 130. The receiver 130 may include a wireless circuitry 140, an image generation module 150, and a classification module 170.

The transmitter 110 may be a router such as a Wi-Fi router, used to provide a wireless local area network (or other such network) within the environment 125. As one example, the transmitter 110 and the receiver 130 may be included in the single wireless router. The transmitter 110 and the receiver 130 may both contain a Medium Access Control (MAC) layer and a Physical Layer (PHY), such as those specified by the IEEE 802.11 standard. Additionally, or alternatively, the transmitter 110 may be an emitter dedicated to Wi-Fi sensing applications. The transmitter 110 may be configured to transmit wireless signals via one or more wireless protocols, such as Wi-Fi, Zigbee, Bluetooth, and/or any other such wireless protocols.

The environment 125 may be any type of environment where a wireless network may be provided. For example, the environment 125 may be a house, a room in a house, a hotel room, etc. In the example shown in FIG. 1, the environment 125 may be a room in a house. Although only one transmitter 110 is shown in one environment 125 is shown, it should be understood that the system 100 may include any number of transmitters, each to the transmitter 110 may be present in any number of environments, each to the environment 125. For example, the transmitter 110 may be a node in a mesh network, where multiple transmitters and receivers may be present. Other nodes may be present in other environments (e.g., other rooms) and communicate with the transmitter 110. Similarly, although only one receiver is shown in the environment 125, it should be understood that the system 100 may include any number of receivers in any number of environments. Thus, the system 100 may be configured to perform Wi-Fi sensing operations in a plurality of environments simultaneously.

The subject 120 may be a living organism which is capable of movement. In some examples, the subject 120 may be a human. In other examples, the subject 120 may be living organism, such as a pet. The subject 120 may be capable of motion. As further described below, the subject 120 may alter one or more aspects of the wireless signals transmitted by the transmitter 120 due to motion and/or its presence within the environment 125 through which wireless signals propagate.

The transmitter 110 may be any device capable of transmitting a wireless signal. For example, the transmitter 110 may include Wi-Fi routers, Wi-Fi access points, Wi-Fi adapters, Wi-Fi repeaters, or mesh network routers. In some examples, such as mesh network routers, each node within the mesh network may act as a transmitter. The transmitter 110 may include circuitry capable of receiving digital instructions and converting those instructions to electric signals. This may include for example, a Radio Frequency (RF) front end, baseband processor (e.g., to handle modulation, error checking, and correction), and a microcontroller. Electrical signals can be provided from circuitry to an antenna which can convert the information into electromagnetic waves (e.g., a wireless signal 114). The transmitter 110 may include other capability or communication interfaces (e.g., ethernet, Bluetooth, NFC, etc.) to allow the transmitter to communication with one or other devices. For example, the transmitter 110 may be a set top box, which may have a co-axial connection to receive signals to provide internet access as well as a Bluetooth connection to receive input from one or more user devices. In some examples, the transmitter 110 may have multiple transmission antennas and/or other physical structures to support various capabilities of Wi-Fi signal transmission, such as for example, the Institute of Electrical and Electronics Engineers (IEEE) 802.11 standard.

The transmitter 110 may emit a Wi-Fi signal or create a Wi-Fi network. The transmitter 110 may include both hardware and software components to achieve transmission of a wireless signal, including configuration of the signal, such as the frequency, bandwidth, modulation, or data transfer rate of the signal. Bandwidth my refer to the range of frequencies that the signal occupies. For example, Wi-Fi signals typically use channel widths of 20 MHz, 40 MHz, 80 MHz, or even 160 MHz in some standards. Wider channels can carry more data, providing higher throughput.

Modulation may refer to a format in which data is encoded into radio waves or wireless waves. For example, modulation schemes may include PSK (phase shift keying), Binary Phase Shift Keying (BPSK), Quadrature Phase Shift Keying (QPSK), Quadrature Amplitude Modulation (QAM). Each modulation scheme determines how data is encoded into radio waves and impacts the data rate and robustness of the signal. BPSK may refer to using two phases to represent binary values, QPSK may refer to the use of four distinct phase shifts to represent data which are 90 degrees shifted from one another, where each phase shift carries two bits of information (e.g., (00, 01, 10, 11)). QAM effectively combines aspects of both amplitude modulation (AM) and phase modulation (PM) to increase the bandwidth efficiency of a system.

The receiver 130 may be any device capable of receiving wireless signals (e.g., the modified wireless signal 116) and processing the received wireless signal. For example, the receiver 130 may be a Wi-Fi router, a Wi-Fi adapter, a Wi-Fi repeater, a mesh network router, a set-top box (e.g., a television receiver), and/or a user device (e.g., a cellular phone, a laptop, etc.). The receiver 130 may include hardware and/or software which may non-transitory computer readable media, processors, and a wireless circuitry 140, an image generation module 150, and a classification module 170. Additional aspects of the receiver 130 are further discussed below.

While illustrated as separate units, the transmitter 110 and the receiver 130 may be housed or contained within the same physical unit. For example, the transmitter 110 and the receiver 130 may both be a portion of a single wireless router, capable of both transmission of wireless signal and receipt of wireless signals.

The wireless circuitry 140 may include any of the following non-limiting components. The components discussed are exemplary and a person of skill in the art will appreciate that other variations are within the scope of the disclosed invention. An antenna may be configured or designed to capture electromagnetic waves at different frequency bands. For example, the router may be configured for 2.4 gigahertz (GhZ) or a 5 GhZ frequency bands. Filters and amplifiers may be included in the receiver 130 or the wireless circuitry 140. A downconverter may be included to transform the high-frequency signal into a lower frequency which may be more suitable to process. After down conversion, a demodulator may take the signal generated from the antenna and extract data by reversing the modulation process which was used at the transmitter. An analog to digital convertor (ADC) may be used to convert analog signals to digital signals, which may be processed by a digital signal processor or other processor contained within the receiver 130. The wireless circuitry may also include other processors to perform any of the functions described herein.

The image generation module 150 of the receiver 130 may include hardware and/or software which is capable of generating images based on information of data obtained from the wireless circuitry 140. For example, the image generation module 150 may contain the capability to generate one or more visual representations of wireless data. The image generation module 150 may be able to represent information related to one or more wireless signals as a scalogram. A scalogram may be a visual representation of a signal's frequency content over time, created using wavelet transforms. In some examples, the image generation module 150 can provide information which can relate to its output, such as the inability to produce an image based on the information which has been received by the image generation module 150.

The classification module 170 of the receiver 130 may contain hardware and/or software to perform classifications. In some examples, the classification module 170 may contain one or more machine learning models (MLMs), rules-based filters, and other such components. The classification module 170 may contain algorithms including decision trees, random forest decision trees, logistic regression, support vector machines, naïve bayes, k-nearest neighbors, neural networks, gradient boosting machines, etc. Additional examples of the image generation module 150 and the classification module 170 may be provided below.

At 103, the transmitter 110 may emit the wireless signal 114. The wireless signal 114 may be a signal which is configured to meet a particular standard, such as for example, the IEEE 802.11 standard. The wireless signal 114 may be a Wi-Fi signal. The wireless signal may include information such as modulation, encoding, amplitude, phase, and/or frequency. The transmitter 110 may be configured to generate more than one type of wireless signal at a time. For example, the transmitter may be capable of generating two wireless signals, such as a 2.4 GhZ wireless signal and a 5 GhZ wireless signal. This may be the case in a “dual-band” transmitter, which can simultaneously generate wireless signals at two frequencies. For example, the IEEE 802.11ac wireless networking standard set of protocols may be met by the transmitter, which may provide signals on the 5 GHz band. The generation of the wireless signal may also include the generation of a wireless local area network. The wireless local area network may include multiple bands or frequencies for simultaneous signal propagation. Each frequency of wireless signal may have different properties with respect to reflectivity, range, physical propagation, transmittivity, etc.

In some examples, the emission of the wireless signal may include the use of a mesh network. The mesh network may be a network which may consist of multiple individual receivers and/or transmitters. The mesh network may have the transmitters and/or receivers physically separated and placed at various locations within an environment. The mesh network may reduce a weak signal due to attenuation of signal strength due to distance, physical obstructions, interference, etc. Thus, the mesh network. In a mesh network, each transmitter may be similar to the transmitter 110. Each transmitter and/or receiver of the mesh network may be used to carry out the aspects of the disclosed technology as described herein.

The wireless signal 114 may be an electromagnetic wave (e.g., a wireless signal, a Wi-Fi signals, or other standard) which may be propagated through space in all directions from the transmitter 110. Although illustrated with a single line, a person of skill in the art will appreciate that the signal is propagated in throughout the environment 125, and may interact with one or more objects in the environment 125, including reflection from solid surfaces, walls, decor, or other objects in environment 125. Similarly, the interaction of the wireless signal 114 with the subject 120 may cause scattering, diffusion, or other physical phenomenon to occur which cause the modified wireless signal to be propagated in multiple directions, which make take independent paths prior to reaching the receiver 130. Thus, the wireless signal 114 may take multiple paths from the transmitter 110 to the receiver 130.

The wireless signal 114 and the modified wireless signal 116 may include or contain within them information related to multiple signal characteristics—e.g., amplitude, frequency, phase, and encoding—altered by the presence of the subject 120. These alterations may occur due to various physical phenomena such as reflection, diffraction, scattering, and absorption when a subject interacts with the signal path. For example, a moving subject might cause fluctuating signal strength, indicative of distance changes from the source, or phase shifts that suggest movement direction or speed. Such signal modifications provide a dataset from which the receiver 130 can extract patterns correlating with specific types of activities, motions, or events. This detailed analysis of altered signals may enable monitoring and classification of subjects or objects within the environment 125. Amplitude data and phase data may be CSI based amplitude data and CSI based phase data, respectively.

During propagation of the wireless signal 114, the wireless signal 114 may interact with the environment 125 and/or the subject 120. The interaction of the wireless signal 114 and the subject 120 may cause the wireless signal to vary or be modified from its original signal to contain new physical properties, such as for example, a phase shift, amplitude change, change in path, change in time taken to reach the receiver 106, etc.

The subject 120 may, through his or her presence, interact with the emitted wireless signals, creating characteristic alterations which may reflect the activity, identity, motion of, or other characteristic of the subject 120. Such alternations may represent various behaviors, such as for example, sitting up, standing, laying down, walking, or smaller motions such as hand gestures. The subject 120 can perform a wide range of activities, from basic movements such as walking and running to more nuanced actions like typing, gesturing, or changes in posture. The capability of the system 100 to discern these varied activities may allow for comprehensive monitoring and analysis, enabling applications that range from enhancing security protocols, generating alerts or notifications, or optimizing smart home settings based on the presence or activity of individuals. The system 100 may also be able to detect a variety of motions or gestures by the subject 120. The subject 120 may also include pets, other organisms, or objects within the environment 125.

At 105, one or more wireless signals may be received by the receiver 130. This may include for example, the wireless signal 114 and/or the modified wireless signal 116. The signals may be received by an antenna or other physical component of the wireless circuitry 140 or of the receiver 130. Induction within an antenna may cause electromagnetic waves to be generated within the wave, which may be converted to electrical signals by the wireless circuitry 140. Filters, amplifiers, a downconverter, and a demodulator may be used at to receive the wireless signals and convert the wireless signal to an electrical signal or other signal within the wireless circuitry. In some examples, receiver 130 may be configured to receive additional information from the transmitter, such as a pilot signal, which may act as a reference signal.

For example, the transmitter 110 may transmit the wireless signal 114 (e.g., a Wi-Fi signal) which interacts with a subject 120. The wireless signal 114 may interact with a subject 120, which in turn may produce or cause a modified wireless signal 116. The modified wireless signal 116 may be received by the wireless circuitry 106 of the receiver 130. Additionally, the receiver 130 may also receive other information from transmitter 110 through the wireless signal 114 or other communication media.

At 107, information may be generated or derived from the received wireless signal (e.g., the data 118). This may include for example, any of the information discussed above with respect to the wireless signal. An analog to digital convertor may also be used to convert the analog signals to digital signals or digital data. For example, the digital data may include time dependent data which may include amplitude, phase, angle of incidence, time of transmission, flight time of a wave, signal strength, noisiness, or other characteristics which are derived from and/or related to wireless signals received by the receiver 130.

The wireless circuitry 140 may provide the data 118 as an output which may be provided to an image generation module 150. The data 118 may include for example, amplitude data, phase data, and/or other data (e.g., signal strength, error estimations, uncertainty, etc.). As further described herein, this information may be obtained after one or more transformations on the wireless signal received by the receiver 130.

At 109, the information may be transformed and/or filtered. The transformation may include the use of one or more transformation techniques. In one example, a continuous wavelet transformation (CWT) technique may be used. A continuous wavelet transform (CWT) may be used to analyze or transform various aspects of a signal, such as frequency over time. CWT is a signal processing technique that decomposes the signal into its constituent frequency components across different scales. The CWT process may involve convolving the input signal with a scaled and translated version of a continuous wavelet function, resulting in a time-frequency representation of the signal. For example, one or more wavelets (which may be in scale or in time) may be shifted or moved along the entire signal and multiplied by a sampling interval to obtain physical significances. This process may result in in coefficients that are a function of wavelet scales and shift parameters. The CWT technique may choose or control the properties of the wavelets which are utilized in this process. Convolution may refer to a mathematical operation which is used in the field of signal processing. In the context of signal processing, it may be described as the process of applying a filter to a signal. In the realm of machine learning and image processing, convolution may be used to highlight features of input data.

Unlike a Fourier transform, which provides a frequency spectrum for the entire signal, the CWT can show how the frequency spectrum changes over time, offering a time-frequency representation of the signal. The CWT may therefore be useful for non-stationary signals whose frequency components vary over time. The CWT may be applied to a signal by continuously shifting a wavelet function over time and scaling it for different frequencies. The wavelet function acts as a small wave with a limited duration. The process involves comparing the signal to the wavelet at various scales (frequencies) and positions (times), effectively mapping how similar the signal is to the wavelet at each scale and position. This technique may be used to analyze both amplitude and phase at various points of time for a given frequency (e.g., 2.4 Ghz, 5 Ghz).

For example, a continuous wavelet transformation may be performed on the analog signal received or generated by the wireless circuitry 240 from the modified wireless signal 116, or a digital representation thereof. In some examples, the CSI the continuous wavelet transformation may be performed on CSI data which is received at the receiver 230.

At 111, phase information, amplitude information, and/or other information may be obtained from the received signal (e.g., the modified wireless signal 116). This information may be obtained after the CWT transformation which may occur at 109. Other processing may be performed at this step, such as removing background information or removing values which are smaller than a certain threshold.

At 113, the image generation module 150 may generate an image 160. The image 160 may be based on the data 118 such as phase information, amplitude information, and/or other information. For example, the phase of the received signal may vary with time, and this information may be used to generate a two-dimensional (2D or 2-D) image which has time as one axis and the phase or phase variation as a second axis. As another example, the amplitude of the image may vary with time. One axis may represent the amplitude of the received signal at a given time while the other axis may represent time. In this manner, one or more images may be generated. In some examples, a series of images may be generated. In some examples, the image may be a scalogram. In some examples, the image 160 may contain features or characteristics which can be analyzed based on rules-based filters and/or machine learning models. As one example, the image 160 may contain patterns which correspond to a particular type of activity. After a machine learning model has been trained, the image 160 can be used to identify, characterize, and/or detect the motion or behavior of the subject 120.

The image generation module 150 may be hardware and/or software which can generate one or more images based on information obtained from the wireless circuitry 140. For example, the image generation module may generate the image 160 based at least in part on amplitude data or based on phase data. The image 160 may be provided to a classification module 110.

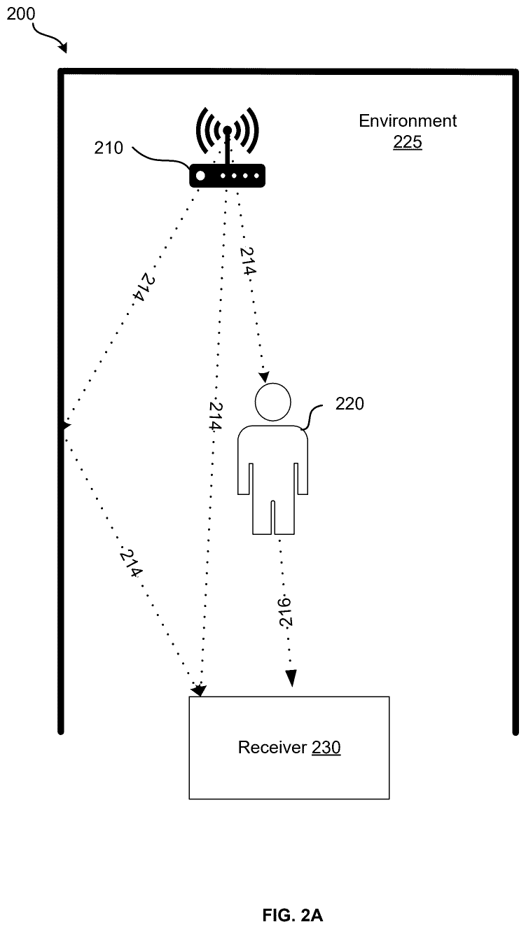

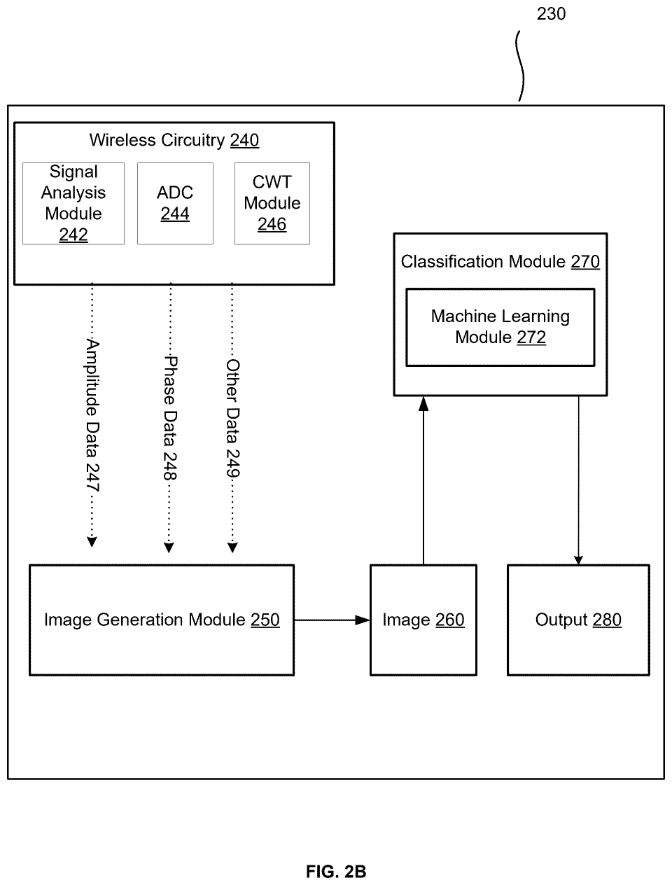

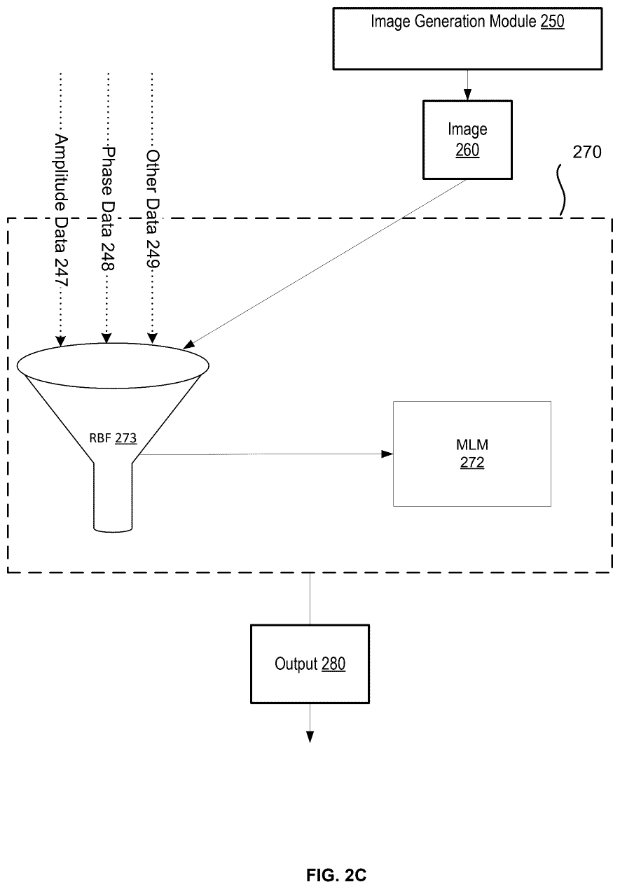

At 115, the classification module 170 may detect one or more characteristics included in the image 160. The one or more characteristics may include time-frequency representation, wavelet coefficients (e.g., the values of wavelet coefficients at various scales), statistical features (mean, variance, skewness, and kurtosis of the wavelet coefficients), texture feature, ridge and contour features (e.g., ridges, and contours present in a scalogram), edge features (e.g., the length, angle, sharpness of an edge between two areas of a scalogram). The one or more characteristics may be used for the determination and/or the detection of activity, gestures, or motion of the subject 120. The image 160 may contain characteristics representing changes over time in the modified wireless signal 116. The classification module 170 may classify these characteristics in order to detect object, an activity, motion, gestures, etc. For example, the image 160 may be a scalogram obtained based on outputs of the wireless circuitry 140. The classification module 170 may classify the scalogram into one of several outputs. Additional aspects of the classification module 170 are discussed below with respect to FIG. 2C.

The classification module 170 may contain various machine learning models (MLMs), rules-based filters, and other classification criteria which may allow an image (and/or aspects thereof) to be classified. For example, a machine learning model may be a convolution neural network (CNN) which takes as input the image 160 (e.g., a scalogram) and outputs a classification which relates to a subject's activity (e.g., walking, sitting, standing, laying down). Rules-based filters may include the use of filters which can broadly classify (or pre-classify an image prior to providing to an MLM) by the type of subject or quality of image (e.g., whether the image can be classified, what type of model to use to classify the model, classifying the image as a “bad” image which should not be used for classification based on localized or instantaneous noise in the image).

In some examples, the classification module 170 may have the ability to receive an input which indicates the type of environment 125 for which it is performing classification. For example, the environment may be one of “residential with pets,” “residential with no pets,” “elderly care home,” “bedroom,” “jazz studio,” “apartment,” “living room,” etc. Additionally, in some examples, the classification module 170 may be aware of the hardware and/or software arrangement of the receiver 140, and make adjustments to parameters of the machine learning model contained thereon based on that information.

At 117, an output 180 may be provided by the classification module 170. The data 118 which is analyzed by the classification module 170 may be transformed into an output 180. Output 180 may be a message which may be used by one or other devices to perform an activity. In some examples, other information may also be provided in connection with the output 180, such as a probability of the classification, other likely classifications, instructions, messages, or data which may be used to cause a user device to display a message and/or perform an action responsive to receipt of the data. In some examples, this information may be shared with one or more user devices through a communication interface of the receiver 140 (e.g., ethernet, Bluetooth, NFC, etc.).

FIG. 2A-2C illustrate a system 200 for detecting objects in an environment. The system 200 may be similar to some or all of the system 100 described in FIG. 1. The system 200 may include a transmitter 210 and a receiver 230 within an environment 225. The transmitter 210 may be similar to the transmitter 110 and the receiver 230 may be similar to the receiver 130. Subject 220 may be similar to the subject 120. Environment 225 may be similar to environment 125.

Referring to FIG. 2A, the transmitter 210 may be any device which is capable of transmitting a wireless signal. Transmitter 210 may emit a Wi-Fi signal or create a Wi-Fi network. The transmitter 210 may include both hardware and software components to achieve transmission of a wireless signal, including configuration of the signal, such as the frequency, bandwidth, modulation, or data transfer rate of the signal The transmitter 210 may be any device capable of transmitting a wireless signal. For example, the transmitter 210 may include Wi-Fi routers, Wi-Fi access points, Wi-Fi adapters, Wi-Fi repeaters, or mesh network routers. In some examples, the transmitter 110 may have multiple transmission antennas and/or other physical structures to support various capabilities of Wi-Fi signal transmission, such as for example, the Institute of Electrical and Electronics Engineers (IEEE) 802.11 standard. Multiple modes of propagation may also be possible, such as for example, multiple input multiple output (MIMO) communication may be possible. Transmitter 210 may include the capabilities of data encoding, modulation techniques (e.g., Quadrature Amplitude Modulation (QAM) or Orthogonal Frequency-Division Multiplexing (OFDM), to encode digital data into radio waves), digital to analog conversion through modulation techniques to transmit data via radio waves over antennas, use of specific frequency bands and channels, and transmission of modulated radio signals. Transmitter 210 may also include the ability to demodulate received signals and error correction techniques to ensure that transmissions are reduced in error. A person of skill in the art will appreciate these and other techniques. Receiver 230 may be any device capable of receiving wireless and processing the received wireless signal. For example, the receiver 230 may be a Wi-Fi router, a Wi-Fi adapter, a Wi-Fi repeater, a mesh network router, a set-top box, or a user device (e.g., a cellular phone, a laptop, etc.).

The transmitter 210 may transmit a wireless signal 214. The wireless signal 214 may be transmitted in all directions within the environment 225. In the example shown in FIG. 2A, multiple lines are illustrated for the wireless signal 224 to illustrate that the signals may be transmitted in multiple directions. Certain signals may be reflected or bounced off walls or other surfaces of the environment 225 prior to reaching the receiver 230. Some wireless signals may reach the receiver 230 directly. Although various paths for a signal are illustrated as dotted lines in FIG. 2A, it should be understood that signals propagate in both time and space. Thus, an environment 125, may have a complex pattern of scattering, reflection, refraction, etc. which may be considered by the receiver 230 in interpreting signals received.

The transmitter 210 may also transmit pilot signals or other reference signals to help determine channel state information (CSI). CSI may refer to known channel properties of a communication link. Channel state information (CSI) may be basically calculated using the pilot signals used during transmission by the transmitter 210 and compared with the received pilot signals at the receiver 230. Other metrics, such as signal to noise ratio (SNR) may indicate the strength of the transmitted signal with respect to the channel noise. CSI information may describe describes how a signal propagates from the transmitter to the receiver and represents the combined effect of, for example, scattering, fading, and power decay with distance. In some examples, CSI information may include signal to noise ratio, signal strength, interference levels, a channel matrix, channel coefficients (which may represent a channel's amplitude and phase shifts introduced on a particular channel, and fading characteristics of a specific channel), spatial information, a channel matrix, a channel estimation error, or other time-varying characteristics.

In some examples, CSI can be determined both by the transmitter 210 and the receiver 230. In some examples, the CSI can be determined using specialized algorithms, including machine learning algorithms such as neural networks. CSI information may also be used by the receiver 230 to “filter out” certain types of data prior to providing to a classification (e.g., a rule based on settings or other criteria determined by the receiver 230.

The wireless signal 214 may be modified by the presence of the subject 220 to produce or create a modified wireless signal 216. The modified wireless signal 216 may be similar to the modified wireless signal 116.

Referring to FIG. 2B, the receiver 230, or components thereof, are illustrated. The wireless circuitry 240 may be similar to the wireless circuitry 140 described above. Wireless circuitry 240 may include a signal analysis module 242, an analog to digital convertor (ADC) 244, and a CWT module 246. The signal analysis module 242 may include hardware and/or software which may be responsible for examining the characteristics of incoming wireless signals. The signal analysis module 242 may analyze various parameters of the signals such as strength, frequency, and quality. The signal analysis module 242 may ensure that the signals are within the desired specifications and may assist in identifying any anomalies or distortions that may affect communication. As one example, the signal analysis module 242 may generate or produce CSI data, which may be used by the system 200.

The analog to digital converter (ADC) 244 may convert analog signals received by the wireless circuitry (e.g., those received by an antenna) into a digital format. The conversion may allow for further digital processing and analysis of the signals. The ADC 244 may ensure that the analog signals are accurately digitized, preserving their integrity and facilitating their subsequent manipulation and interpretation by the digital components of the wireless circuitry 240.

The Continuous Wavelet Transformation (CWT) module 246 may process signals using wavelet transforms to analyze different frequency components at various scales. The CWT module 246 may identify and isolate specific features within a signal. The CWT module 244 enhances the ability to detect, interpret, and manage complex signal patterns, making the wireless circuitry more robust and efficient in handling diverse communication scenarios. In some examples, the CWT module 246 may process analog data (e.g., the wireless signal before the ADC). In some examples, the CWT module 246 may process digital data (e.g., data after conversion into a digital format by ADC 244). The CWT may be applied on the CSI data (e.g., OFDM signal phase and OFDM amplitude), which may enable the understanding of RF channel parameters (e.g., those used by the transmitter 210 or those used by the receiver 230).

Data may be processed by the CWT module 246 by using a using CWT transformation. CWT is an efficient transformation in determining the damping ratio of oscillating signals (e.g. identification of damping in dynamic systems). The Continuous Wavelet Transform (CWT) may provide a high localization in time and frequency by continuously varying the scale and translation (shifting) parameter of the wavelets. CWT may also be resistant to the noise in the signal. The wavelet transforms of a continuous time signal x (t) may be defined mathematically as below. The wavelet transform may be performed on digital data by discretizing the time values, and performing summations which are equivalent or approximate to the integral expression below.

$$X ( a , b ) = \frac{1}{\sqrt{\vert a \vert}} {\int }_{- ∞}^{∞} x ( t ) {ψ}^{*} ( \frac{t - b}{a} ) dt$$

In the above expression, “a” may refer to a “scale’ and may be any positive real number. “B” may be a translation value, which may also any real valued number. ψ(t) may refer to a function which may be continuous in both a time domain and a frequency domain, ψ*(t) may refer to a complex conjugate of the same function. A CWT may have a granularity based on determining or adjusting values for both ‘a’ and ‘b’ The scale factor a may be considered to either dilate or compress a signal. When the scale factor is relatively low, the signal may be more contracted, which may result in a more detailed resulting graph. However, a low scale factor may not last for the entire duration of the signal. When the scale factor may be high, the signal may be stretched out, which may imply that the resulting scalogram or graph may be presented in less detail. However, a larger scale may last the entire duration of the signal. The scale may be adjusted to obtain higher accuracy in classifications.

Due to the high removal of noise by CWT, various pre-processing steps need to not be performed by the wireless circuitry 240. As one example, certain filters may not be used when generating data or information from one or more wireless signals. In some examples, other analysis techniques, such as principal component analysis, may not be used when generating or determining information from a wireless signal. The use of CWT may provide data which is low in noise and high in accuracy, which may later be used by one or more components of the wireless circuitry 240 to perform classification and/or provide an output 280.

The CWT module 246 may perform the analysis on more than one component, including on the amplitude and/or phase of the modified wireless signal 216 and/or the wireless signal 214. In some examples, the CWT module 246 may have multiple settings. Granularity may refer to a size (e.g., time, frequency, other choice of parameters) of the CWT wavelets used in analysis and/or to transform one or more signals described herein. For example, the granularity of the CWT may be adjusted on a sliding scale with preset values at each scale, and the scale chosen may be part of machine learning training. As one example, a higher granularity may be used when additional processing power is available at the receiver 230. In some examples, the granularity of the CWT may be adjusted based on the noise in the environment 225. As further explained below, the CWT module 246 may be configured to provide the best type of information to the classification module 270.

The wireless circuitry 240 may generate an amplitude data 247, a phase data 248, and an other data 249 in a digital and/or analog format. The amplitude data 247 may include information of the amplitude of one or more received signals over time. The phase data 248 may include information related to the phase of one or more received signals over time. Other data may include other information related to encoding, transmission source, and/or transmission standard. The wireless circuitry 240 may also distinguish between one or more of the signals received. For example, wireless circuitry 240 may distinguish between the modified wireless signal 216 and the wireless signal 214.

The image generation module 250 may take one or more sources of information provided by the wireless circuitry to generate images, such as the image 260. The image generation module 250 and the image 260 may be similar to the image generation module 150 and the image 160, described above with respect to FIG. 1, respectively. Although a description is provided herein with respect to images, a person of skill in the art will appreciate that alternative embodiments may be possible. The image generation module 250 may generate an image 260, which may be a scalogram. A scalogram is a visual representation of the magnitude of the coefficients obtained from a Continuous Wavelet Transform (CWT) of a signal, or other transformation techniques applied to a signal. The scalogram may be a two-dimensional plot that shows how the frequency content of the signal varies over time. The axes of the scalogram typically represent time and scale (or frequency), while the color or intensity at each point in the plot represents the magnitude of the wavelet coefficients at that specific time and scale. The coefficients may be for the phase and/or amplitude of the signal. The “X” axis or the horizontal axis of the scalogram may be represent a time or duration of a signal. The “Y” axis may represent the range of scales which are used in a wavelet transform. The “color” may represent the magnitude of a coefficient and/or value.

Image 260 may be generated based on the modified wireless signal 216. This signal may be modified based on activity of subject 220 and/or the presence of subject 220. This modified wireless signal may produce an image 260 which may represent a particular activity of subject 220. For example, an image 260 may have characteristics which represent a particular activity. These characteristics and/or features may be present in image 260, which may be analyzed by a machine learning model or a computer vision module, or and may be visually represented on image 260 (e.g., particular patterns which represent sitting or standing on a scalogram).

The classification module 270, which may be similar to the classification module 170, may thus use the image 260 to classify and event. For example, in the case of Wi-Fi signals, classification module 270 may leverage machine learning algorithms to analyze the processed Wi-Fi signals. Classification module 270 may classify signals into predefined categories of human activities. For example, the classification module 270 module can distinguish between various types of movements and behaviors by comparing the signal characteristics isolated by CWT techniques against a dataset of activity patterns. The classification module 270 may be updated and adapted to increase its accuracy over time. over time, enabling the system to provide precise activity detection and monitoring within the environment.

The machine learning module 272 may be included within the classification module 270. The classification module 270 may do so based on one or more algorithms and/or techniques. For example, classification module 270 may contain algorithms including decision trees, random forest decision trees, logistic regression, support vector machines, naïve bayes, k-nearest neighbors, neural networks, gradient boosting machines, etc.

As one example, the machine learning module 272 may contain a convolution neural network. Convolutional Neural Networks (CNNs) are a specialized kind of Deep Neural Networks. CNNs are composed of multiple layers that transform the input volume (such as an image) into an output volume (e.g., class scores) through a series of differentiable operations. The classification module 270 may take as an input, the image 260, and provide as an output, an output 280. The output 280 may be similar to the output 180 described above.

FIG. 2C illustrates additional aspects of system 200. The image generation module 250 may generate the image 260 which may be classified and/or analyzed by the classification module 270. Additionally, the classification module 270 may generate the output 280. Additional aspects of the classification module 270 are described below.

A rules-based filter (RBF) 273 may be a rule-based filters that applies specific criteria to classify images. These filters may use predefined rules, such as threshold values for certain features like color intensity, shape, or texture, to make initial classifications. In some examples, the rules-based filter 273 may receive other information from the wireless circuitry 240, including for example, an error message, a “low quality” indication, an indication of a threshold variation in the environment 225 has not taken place, a “high noise” indication (e.g., when there is an indication that the image is too noisy), etc. This filter may be used to pre-filter images prior to providing classification. Additionally, as multiple images may be generated by the image generation module 250 over time, and as some events only occur for a few seconds at a time, pre-filtering through the rules-based filter 273 may allow for energy and/or computation efficiency savings. In some examples, the RBF 273 may also obtain the amplitude data 247, the phase data 248, and other data 249, and make determinations based on that. For example, if the amplitude data 247 is not sufficient, an image generated based on amplitude data may not be used for classification. As another example, if the RSSI received at a point of time is lower than a threshold value, the filter may reject that signal. The filter may also filter out certain signals or types of patterns prior to analysis based on user inputs or preferences (e.g., whether the user indicates that he has young children and/or pets).

Machine learning module 272 may be a block which includes one or more machine learning models employed within the classification module 270. These models, which may include convolutional neural networks (CNNs), support vector machines (SVMs), and random forests, further refine the classifications. CNNs may be particularly effective for image classification tasks due to their ability to automatically detect important features within images. SVMs are useful for high-dimensional spaces and are effective when the number of dimensions exceeds the number of samples. Random forests, an ensemble learning method, operate by constructing a multitude of decision trees and outputting the class that is the mode of the classes of the individual trees.

The image 260 may have features or patterns which may be recognizable by a human eye. Thus, a model which provides quick and easy classification may be used for certain types of activity detection. In these examples, a model which is computationally less intensive while providing higher accuracy is desirable. Thus, in some examples, the CNN model may include a variety of “light weight” models.

One example of such a “light weight” model is a CNN LeNet-5 model. The LeNet-5 model may use CWT to remove the noise from CSI data which is obtained. At a high level, LeNet (and/or LeNet-5) consists of two parts: (i) a convolutional encoder consisting of two convolutional layers; and (ii) a dense block consisting of three fully connected layers. The first layer convolution layer may apply or use one or more convolutional filters to the input data, capturing essential features and/or reducing dimensionality of data. The second convolution layer may further process the feature maps generated by the first layer, extracting more complex features. A dense block may consist of three fully connected layers. The first fully connected layer, which may take the output from the aforementioned convolution layers and may start to consolidate the features into a format suitable for classification. The second fully connected layer may further refine the data representation, enhancing the model's ability to distinguish between different classes. The third fully connected layer may finalize the data consolidation and produces an output classification. The output classification may be modified or adjusted based on other information to provide an output 280.

In some examples, the machine learning module 272 may include algorithms to allow for the selection of a model based on the hardware and/or software of the receiver 230. For example, specific MLMs may be configured or better tuned for specific types of receivers. For example, for a set top box (STB), a MLM model may be chosen such that the MLM may provide a classification within a set period of time (e.g., less than one second). In such cases, a model may be chosen based on the computational power and/or physical structure of a receiver within the STB. In such examples, the accuracy of the MLM may be reduced to allow for a “quick” classification. In other examples, such as when there is more processing power, a different model may be used which may provide higher accuracy or consider additional information when making a determination. In this manner, the machine learning module 272 may contain a variety of MLMs, which may be updated and selected based on the hardware and/or software of the receiver 240 in which the machine learning module 272 is located, stored, and/or instantiated.

As another example, a MLM stored on the machine learning module 272 may be adjusted based on the physical dimension of a wireless signal. For example, transmitter 210 may emit a 5 Ghz signal. The “resolution” for sensing for the 5 Ghz signal is roughly on the order of 6 centimeters. For a higher Ghz signal, a higher resolution can be achieved. In some examples, such as in dual-band Wi-Fi. For example, transmitter 110 may transmit two signals at two frequencies (e.g., 2.4 Ghz and 5 Ghz). Each of the two signals may be received by the receiver 130. Information derived from the two signals at two different frequencies can be obtained. This information can allow for the validation of the analysis performed by each signal with respect to one another. A different MLM may trained and used for each frequency. These different models may be stored in the machine learning module 272. Each frequency may allow for a separate classification. This may allow for effects of interference patterns within an environment to be mitigated.

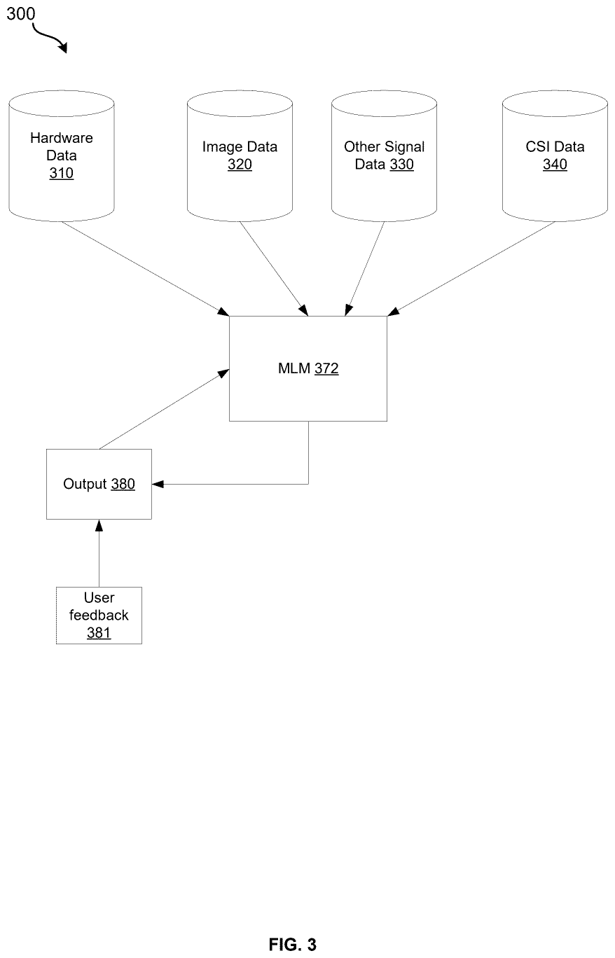

FIG. 3 illustrates training of one or more machine learning models (MLMs) according to example embodiments of the disclosed technology. Illustrated in FIG. 3 is system 300. System 300 has a number of datasets which may be used for training a machine learning model 372, such as hardware data 310, image data 320, other signal data 330, and CSI data 340. The machine learning module 372 may be similar to the machine learning module 272. Each of the datasets may also have data which is related or connected to a time value, allowing data from different datasets to be cross-referenced or used in the training process.

The hardware data 310 may include information related to the physical transmission and/or receipt of a wireless signal, including sensors, receivers, transmitters, antennas, make, model, known operational parameters, etc. The hardware data 310 may include information about a transmitter. For example, the transmitter may have various characteristics, operational parameters, performance parameters, configuration modes, etc., which may affect the transmission and reception of wireless signals. The information at hardware data 310 may be linked or used to train the MLM. Thus, the MLM may be able to identify information about the transmitter to better analyze signal data which is received by a receiver. In some examples, the hardware data 310 can be classified into one or more types of hardware for a wireless signal, such as a primary node, an ancillary node, etc. The hardware data can also include specific information regarding interference, processing used, modulation, and/or frequency of a transmitted or received wireless signal.

The image data 320 may be include one or more scalograms on which a machine learning model may be trained. Image data 320 may include information or metadata related to the image, such as the annotated with information regarding a classification, such as “sitting down,” “walking,” etc. The metadata related to a specific image or scalogram may be time information, how the image was generated (e.g., the type of CWT transform used or pre-processing (such as how aggressive the CWT transform is)), etc. Additional information may include whether the image was generated from an amplitude or phase component of a received wireless signal. These images may have been generated using an image generation module 250.

The other signal data 330 may include the type of environment, the background default of the environment (e.g., the long term average of the environment), the noisiness of the environment (e.g., RSSI, signal-to-noise ratio, packet loss rate), etc. Other information which may be included at this block may include received Signal Strength Indicator (RSSI), packet data, signal-to-noise ratio (SNR), angle of arrival, time of flight, etc. In some examples, the other signal data 330 may include for example “bad samples” which can be used to train the machine learning model to detect and avoid classification of signals from which a classification is not possible.

Channel State Information (CSI) data 340 may include detailed data about the channel properties between the transmitter and receiver. For example, CSI information may have information of a transmitted or received signal which is broken down into carriers or individual subcarriers (small frequency bands). This may be the case in, for example, orthogonal frequency-division multiplexing (OFDM) systems.

A combined dataset may be generated based on the hardware data 310, the image data 320, and the signal data 330. The combined dataset may also be split into training, validation, and test sets, enabling the iterative refinement of the machine learning model. The training set may include preprocessing and labeling of the training dataset may occur. In the training set, only a subset of data which is useful or of a certain criterion suitable for training may be used to ensure a high-quality training set. A validation dataset may be used to fine tune aspects of the model and to assess the performance of one or more trained MLMs. One or more metrics related to the machine learning models performance may be improved. This process may take place iteratively. In some examples, the model parameters may be adjusted or the choice of training algorithm may be changed. The test dataset may be used to test the model to evaluate its performance (e.g., accuracy, number of false positives, the use of a confusion matrix, etc.).

The output 380 may be similar to the output 280 and be a classification or other output provided by the machine learning model. As one example, the output 380 may be a classification for a given input and the probability or confidence of that output. The output may be provided to a user to provide user feedback 381. The user feedback 381 may be part of the training process of the machine learning model. In some examples, the user feedback 381 may be used to update an MLM when the MLM is in the field or operational in an environment. This may allow the machine learning model to adjust for variances in a specific environment and/or for a specific subject.

In some examples, supervised learning models may be used. In this example, models may be trained on a labeled dataset. For instance, each training example for the machine learning model may be paired with an output label. In the training process, the model learns to predict an output from an input set of data. Examples may include linear regression for continuous outputs and logistic regression, support vector machines (SVMs), and neural networks for categorical outputs. Additional examples may include unsupervised learning models. Such models work with unlabeled data. Techniques which may be used include clustering (e.g., k-means, hierarchical clustering) and dimensionality reduction (e.g., principal component analysis, auto-encoders, etc.). Other examples may include semi-supervised learning processes. This involves a combination of a small amount of labeled data and a large amount of unlabeled data. The model leverages the labeled data to learn better representations of the unlabeled data, improving its performance.

In some examples, reinforcement learning techniques may be used. In some examples, models may be trained or “learn” to make sequences of decisions by interacting with an environment to achieve a goal. The learning is guided by rewards, where the model seeks to maximize its total reward. Examples include game playing, robotic navigation, and online recommendation systems.

In some examples, additional types of machine learning models, techniques, or training methods may be used. In some examples, a Recurrent Neural Network (RNN) may be used. A Recurrent Neural Network (RNN) is a class of artificial neural networks where connections between nodes form a directed graph along a temporal sequence. This structure allows RNNs to exhibit temporal dynamic behavior and to process sequences of inputs. This makes them particularly suitable for applications where the time aspect of data is useful. RNN architecture involves a layer of neurons that are connected in a loop, allowing information to persist. Variants of the RNN network, including Long Short-Term Memory (LSTM) may be used. LSTM is designed to overcome a problem of a vanishing gradient in RNNs and is capable of achieving learning long-term dependencies. Gated Recurrent Units, which are a simplified version of LSTMs may also be used. GRUs use a different gating mechanism than LSTMs and are effective at capturing long-term dependencies. Convolutional Neural Networks (CNNs) are a specialized kind of Deep Neural Networks. CNNs are composed of multiple layers that transform the input volume (such as an image) into an output volume (e.g., class scores) through a series of differentiable operations.

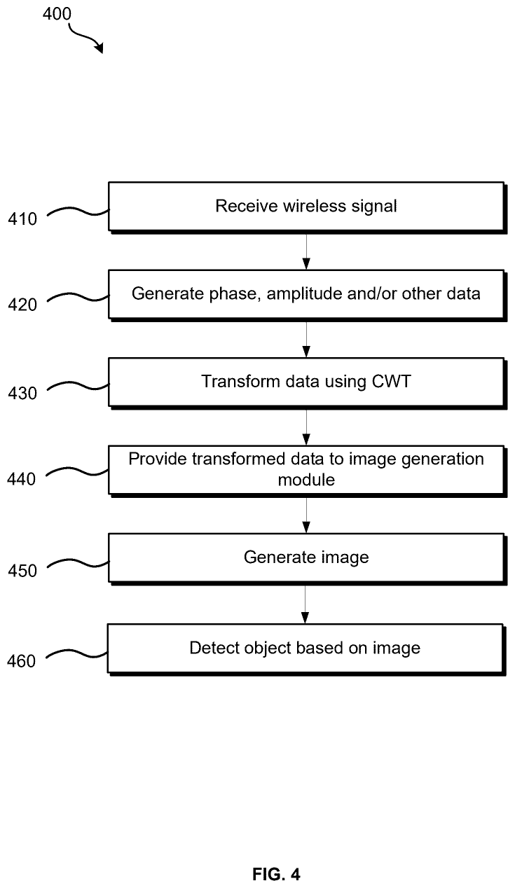

FIG. 4 illustrates a flowchart of a method 400 for detecting objects within an environment, according to certain embodiments. The method 400 may be performed by some or all of the systems and devices described herein. For example, the method 400 may be performed by the systems 100 and/or 200, working alone or in conjunction with each other. The steps of the method 400 may be performed in a different order than is shown and described, and/or some steps may be combined. In some embodiments, some steps may be skipped altogether.

At step 410, the method 400 may include, receiving, by a wireless circuitry of a receiver, a wireless signal from the environment. The receiver may be similar to the receiver 130 of FIG. 1 or the receiver 230 of FIG. 2A. The wireless circuitry may be similar to the wireless circuitry 140 of FIG. 1 or the wireless circuitry 240 of FIG. 2A. The wireless signal received may be similar to the wireless signal 114 and/or modified wireless signal 116 of FIG. 1. The wireless signal may also be similar to the wireless signal 214 and/or modified wireless signal 216 of FIG. 2. The wireless signals received may be emitted from a transmitter and received at the receiver. The wireless signals received may include or contain within them information related to multiple signal characteristics—e.g., amplitude, frequency, phase, and encoding-altered by the presence of a subject within an environment. These alterations may occur due to various physical phenomena such as reflection, diffraction, scattering, and absorption when a subject interacts with the signal path. For example, a moving subject might cause fluctuating signal strength, indicative of distance changes from the source, or phase shifts that suggest movement direction or speed. Such signal modifications provide a dataset from which the receiver can extract patterns correlating with specific types of activities, motions, or events. This analysis of altered signals may enable monitoring and classification of subjects or objects within an environment.

At step 420, the method 400 may include determining, by the wireless circuitry of the receiver, at least one of phase information or amplitude information associated with the wireless signal. For example, the wireless circuitry of the receiver may generate amplitude information and/or phase information, and additionally, other data and/or information. Such data may be generated in a digital or analog format. The amplitude information may include information of the amplitude of one or more received signals over time. The phase information may include information related to the phase of one or more received signals over time. Other information and/or data may include other information related to encoding, transmission source, and/or transmission standard. The wireless circuitry may also distinguish between one or more of the signals received. For example, wireless circuitry may distinguish between a modified wireless signal and a wireless signal 214.

At step 430, the method 400 may include generating, by the receiver using continuous wavelet transformation, at least one of phase data or amplitude data based on the phase information or the amplitude information, respectively. For example, a Continuous Wavelet Transform (CWT) module (e.g., similar to the CWT module 246)) may process signals using wavelet transforms to analyze different frequency components at various scales. This module may identify and isolate specific features within a signal. In some examples, the CWT module 246 may process analog data (e.g., the wireless signal before the ADC). In some examples, the CWT module 246 may process digital data (e.g., data after conversion into a digital format by ADC 244). The CWT model may thus transform the phase information and/or the amplitude information.

At step 440, the method 400 may include providing, by the wireless circuitry of the receiver, at least one of the phase data or the amplitude data to an image generation module executed by the receiver. The image generation module of the receiver may be similar to the image generation module 150 of the receiver 130 or the image generation module 250 of the receiver 230. The image generation module may include hardware and/or software which is capable of generating images based on information of data obtained from the wireless circuitry. For example, the image generation module may contain the capability to generate one or more visual representations of wireless data. For example, image generation module is able to represent information related to one or more wireless signals as a scalogram. A scalogram is a visual representation of a signal's frequency content over time, created using wavelet transforms. In some examples, the image generation module can provide information which can relate to its output, such as the inability to produce an image based on the information which has been received by the image generation module.

At step 450, the method 400 may include processing, by the image generation module executed by the receiver, at least one of the phase data or the amplitude data to generate an image of the environment. The image of the environment may contain aspects of a signal modified due to activity and/or the presence of a subject. For example, the image generation module is able to represent information related to one or more wireless signals as a scalogram. A scalogram is a visual representation of a signal's frequency content over time, created using wavelet transforms. In some examples, the image generation module can provide information which can relate to its output, such as the inability to produce an image based on the information which has been received by the image generation module. The image may be similar to image 150 or the image 250.

At step 460, the method 400 may include detecting, by the receiver and based on the image, the object within the environment. The detection of an object within the environment may include detecting activity and/or motion of a subject within the environment. The detection may also include classification of a subject and/or activity of the subject. For example, a classification module (e.g., similar to the classification module 170 or the classification module 270) may detect one or more characteristics included in an image, including for example, the detection of activity, gestures, or motion of a subject. For example, the image 160 may contain characteristics representing changes over time in the modified wireless signal. The classification module may classify these characteristics in order to detect object, an activity, motion, gestures, etc. The image may be a scalogram obtained based on outputs of wireless circuitry. The classification module may classify the scalogram into one of several outputs. Additional aspects of the classification module and classification techniques are discussed herein, such as are described to FIG. 2C. The classification may be provided as an output (e.g., similar to the output 180 or the output 280).

In various embodiments, a specific machine learning model can be selected or chosen for classification depending on the environment, the number of transmitters or receivers, the noisiness of the environment, the model of the transmitter or receiver etc. For example, a lightweight or edge AI model may be used. An edge AI model may be a model which is executed only on the receiver, and does not communicate with a server. In some examples, other protocols can be run to “zero-out” the environment during times in which the environment may be considered to be inactive (e.g., at 3 am in the morning). This may allow for variations in the environment to be removed, such as change in the furniture. This background effect may be removed when generating or analyzing signals to better account for the effect the subject has on changing the wireless signal. Other MLMs or settings may be chosen based on user input (e.g., if the user indicates that he has young children and/or pets).

In various embodiments, classification can occur twice from the same signal. For example, amplitude information of a received signal can be used to create a first classification, and the phase information of a received signal can be to produce a second classification. The first classification and the second classification can be used to verify one another, and reduce the number of false positives. Thus, with the same information (e.g., the same received wireless signal), and at the same time, transient information can be used to produce two classifications of the same signal, which can be used to increase the accuracy of a classification.

For example, the amplitude information can generate a first image while the phase information can generate a second image. Each image can be analyzed by a separate classification module. One classification module may contain a MLM which is only configured to analyze amplitude data while the other classification module may contain an MLM which is only configured to analyze phase data. Each classification module may generate a separate classification. The classifications may be checked against one another.

In various embodiments, the machine learning model, or other control module, may control and/or influence the strength of signal processing, such as the level of filtering, or the nature of the CWT model used.

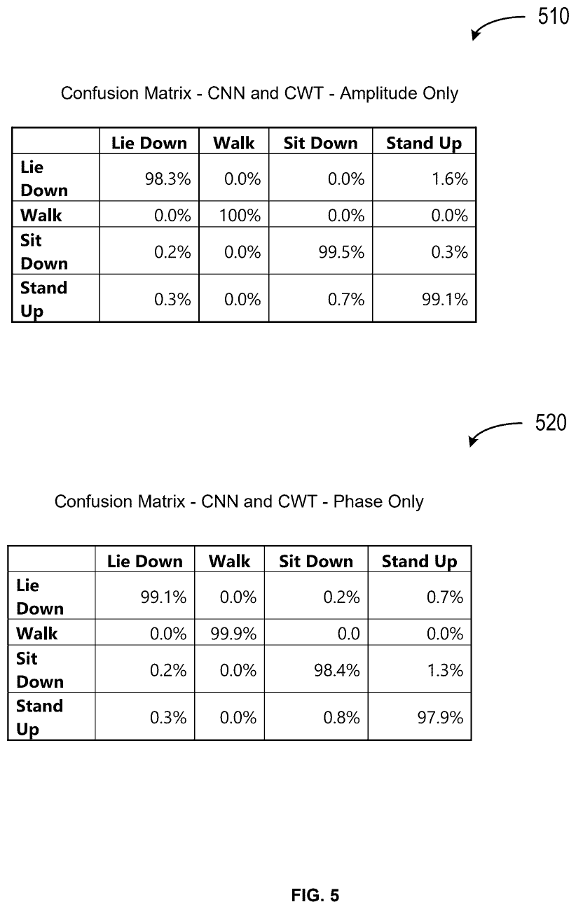

FIG. 5 illustrates various experimental results gathered using a CNN and CWT transformations on Wi-Fi sensing data, according to certain embodiments. The machine learning model used to analyze the data is based on CNN LeNet-5 and uses CWT to remove the noise from CSI data. FIG. 5 illustrates tables 510 and 520. Table 510 may show classifications made using only amplitude data. Only phase data is used to make classifications for table 520. The four tasks which are detected for a subject are—“lie down,” “walk,” “sit down,” and “stand up.” For these results, CSI amplitude data or CSI phase data is transformed using CWT transformation, The CWT co-efficient was fed to a CNN LeNET-5 model. These results show the improvement of the techniques in outperforming existing techniques, with a minimum accuracy of around 98%. This illustrates how a CWT transformation helps to reduce noise and how a LeNET-5 model can classify the data with high accuracy.

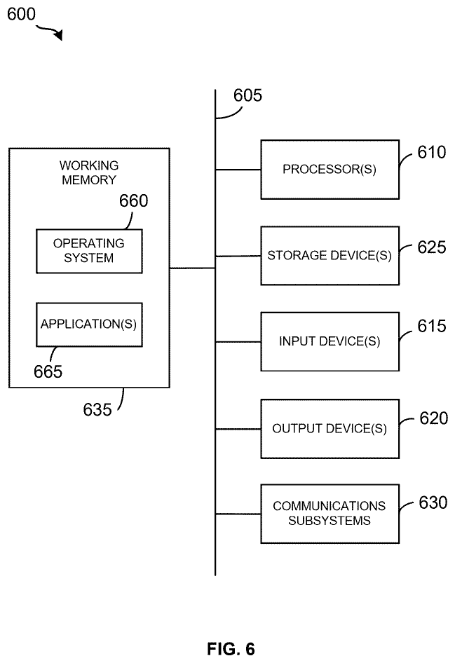

FIG. 6 is a schematic diagram illustrating an example of computer system 600. The computer system 600 is a simplified computer system that can be used to implement various embodiments described and illustrated herein. A computer system 600 as illustrated in FIG. 6 may be incorporated into devices such as a portable electronic device, mobile phone, or other device as described herein. FIG. 6 provides a schematic illustration of one embodiment of a computer system 600 that can perform some or all of the steps of the methods and workflows provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown including hardware elements that can be electrically coupled via a bus 605, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 615, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 660, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g., the first electronic device, may be incorporated into the computer system 600, e.g., an electronic device as an input device 615. In some embodiments, the computer system 600 will further include a working memory 635, which can include a RAM or ROM device, as described above.

The computer system 600 also can include software elements, shown as being currently located within the working memory 635, including an operating system 660, device drivers, executable libraries, and/or other code, such as one or more application programs 665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the operations of such methods are performed by the computer system 600 in response to processor 610 executing one or more sequences of one or more instructions, which might be incorporated into the operating system 660 and/or other code, such as an application program 665, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method for detecting an object in an environment using a wireless signal, the method comprising:
receiving, by a wireless circuitry of a receiver, a wireless signal from the environment;
determining, by the wireless circuitry of the receiver, at least one of phase information or amplitude information associated with the wireless signal;
generating, by the receiver and using continuous wavelet transformation, at least one of phase data or amplitude data based on the phase information or the amplitude information, respectively;
providing, by the wireless circuitry of the receiver, at least one of the phase data or the amplitude data to an image generation module executed by the receiver;
processing, by the image generation module executed by the receiver, at least one of the phase data or the amplitude data to generate an image of the environment; and
detecting, by the receiver and based on the image, the object within the environment.

2. The method of claim 1, wherein detecting the object further comprises:
receiving, by a machine learning model implemented on the receiver, an input comprising the image of the environment;
identifying, by the machine learning model implemented on the receiver, the object; and
outputting, by the machine learning model implemented on the receiver, data indicating the object.

3. The method of claim 2, further comprising:
providing a data set comprising at least one of the phase information, the amplitude information, or the data indicating the object to the machine learning model; and
retraining the machine learning model using the data set.

4. The method of claim 2, wherein the machine learning model is a convolution neural network.

5. The method of claim 4, wherein the convolution neural network is a LeNet-5 model.

6. The method of claim 1, wherein the amplitude information comprises CSI amplitude information.

7. The method of claim 1, wherein the phase information comprises CSI phase information.

8. The method of claim 1, further comprising:
performing, by the receiver, principal component analysis on at least one of the phase information or the amplitude information.

9. The method of claim 1, further comprising:
determining, by the receiver, channel state information associated with the wireless signal.

10. The method of claim 1, wherein the receiver is a set top box.

11. A system for detecting an object in an environment using a modified wireless signal, comprising:
a transmitter configured to transmit an emitted wireless signal;
a receiver, comprising:
a wireless circuitry;
an image generation module;
one or more processors; and
a computer memory comprising instructions that, when executed by the one or more processors, cause the system to perform operations to:
receive, by the wireless circuitry of a receiver, the modified wireless signal from the environment, the modified wireless signal based on the emitted wireless signal modified by the object in the environment;
determine, by the wireless circuitry of the receiver, at least one of phase information or amplitude information associated with the modified wireless signal;
generate, by the receiver using continuous wavelet transformation, at least one of phase data or amplitude data based on the phase information or the amplitude information, respectively;
provide, by the receiver, at least one of the phase data or the amplitude data to the image generation module executed by the receiver;
process, by the image generation module executed by the receiver, at least one of the phase data or the amplitude data to generate an image of the environment; and
detect, by the receiver and based on the image, the object within the environment based on the modified wireless signal.

12. The system of claim 11 wherein the transmitter and the receiver are configured to provide a wireless network.

13. The system of claim 11 wherein detection of the object within the environment further comprises detecting motion of the object.

14. The system of claim 13, wherein the system utilizes a classification model to classify the motion of the object into one or more classifications.

15. The system of claim 11 wherein the transmitter or the receiver is a set top box.

16. The system of claim 11, wherein the system further comprises an edge AI machine learning model.

17. A non-transitory computer-readable medium comprising instructions, that, when executed by one or more processors, cause the one or more processors to perform operations comprising:
receive, by a wireless circuitry of a receiver, a wireless signal from an environment;
determine, by the wireless circuitry of the receiver, at least one of phase information or amplitude information associated with the wireless signal;
generate, by the receiver using continuous wavelet transformation, at least one of phase data or amplitude data based on the phase information or the amplitude information, respectively;
provide, by the wireless circuitry of the receiver, at least one of the phase data or the amplitude data to an image generation module executed by the receiver;
process, by the image generation module executed by the receiver, at least one of the phase data or the amplitude data to generate an image of the environment; and
detect, by the receiver and based on the image, an object within the environment.

18. The non-transitory computer-readable medium of claim 17, wherein the amplitude information comprises CSI amplitude information.

19. The non-transitory computer-readable medium of claim 17, wherein the phase information comprises CSI phase information.

20. The non-transitory computer-readable medium of claim 17, the operations further comprising:
performing, by the receiver, principal component analysis on at least one of the phase information or the amplitude information.
